(19) United States
(12) Patent Application Publication
(10) Pub. No.: US 2007/0130148 A1
(43) Pub. Date: Jun. 7, 2007

(54) Real-time overall monitor system

(76) Inventor: Chao-Hung Wu, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/293,228

(22) Filed: Dec. 5, 2005

(51) Int. Cl. G06F 17/30

(52) U.S. Cl. 707/9

(57) ABSTRACT

A real-time overall monitor system according to this invention may keep track of the executive states of activities done by employees, comprising client computers and a monitor server. The client computers are mainly used by the employees to do all kinds of activities in working hours, and after the activities are done for file upload, Internet surfing, or web phone, they send activity records. The monitor server uses the record monitor database and the record module to monitor all the outward activities on the client computers. Each monitor record comprises at least an employee ID, an activity type, and start/end time, so a supervisor may easily know what the certain employees did in certain time.

### BACKGROUND OF THE INVENTION

1. Field of the Invention

This invention relates to a real-time overall monitor system and particularly to that receiving and collecting activity records given out of a client computer to monitor.

2. Description of Related Art

According to a questionnaire offered by IDC, 30% or even 40% data stream over enterprise network is consumed in working hours by employees for personal affairs, thereby the efficiency being lost and up to millions of US dollars being consumed. SexTracker also pointed out that around 70% data flow is transmitted in working hours for visit to porn websites.

Even if the enterprise racks its brand to set various measures to prevent the employees from going to the Internet for personal affairs in working hours, the employees still may do their personal affairs by telephone, fax, email and the like. Thus, it should be enough for them to spend 70% time in a working day being involved in their works.

In order to prevent the employees from dealing with their personal affairs, each company tries to carry out every kind of management approach or supervisors supervise the employees at any time to prevent the circumstance from being out of control. However, overmuch supervision will bring harassment to work on the contrary; besides, even if it is determined that the employees do not deal with their personal affairs in working hours, it is not yet ascertained that they are earnestly involved in their jobs.

For example, the employee answer only 20 mails of 200 mails received daily; being asked to give calls to 30 companies, the employee gives calls to 10 companies only; being asked to aggressively visit customers every day, the employee visits only 1 or 2 customers a week; being asked to input and customers' data and information to a specified address book for storage, the employee usually store it in his or her personal computer and thus seldom update the specified address book; the supervisor almost cannot keep track of the employee's schedule.

All the data and information is kept by each employee himself or herself, so only he or she who keeps the data and information knows which directory the data and information is stored in. Thus, every time an employee resigns or asks for leave, he or she who need the employee's documents or data is hindered.

Accordingly, in the conventional enterprise management, all kinds of activities cannot all the time be monitored completely and timely and enough managers must be required to properly supervise.

### SUMMARY OF THE INVENTION

It is a main object of this invention to provide a real-time overall monitor system. The employees are forced to use client computers to work, so all the outward activities, such as file upload, Internet surfing, web phone, e-mailing and the like, from the client computers are monitored through a record monitor database and a record module, thereby all kinds of activities of employees in working hours being overall monitored.

It is a secondary object of this invention to provide a real-time overall monitor system. Suites of application are provided in the client computer for file upload, Internet surfing, web phone, e-mailing, data fax and scan, scheduling, video conversation, video message leaving, video handwritten papers and reports, handwritten information, address book as activities in working hours and the employees must use the suites of application to do activities they may in working hours, so all the outward and personal activities done by the employees using the client computers are monitored and overall controlled.

According to the objects above, the real-time overall monitor system may keep track of the executive states of activities done by the employees, comprising the client computers and a monitor server. The client computer is mainly used by the employees to do all kinds of activities in working hours, and after the activities are done for file upload, Internet surfing, or web phone, it sends activity records.

The file upload module is used to upload files and activities for the same and then sends activity records. An Internet surfing module is used for Internet surfing and may access information on a website over Internet, and it gives activity records after the Internet surfing. A web phone module is provided for activities on the web phone and may dial receive telephone numbers on Internet for conversation, and after the conversation, it sends activity records. An e-mailing module is provided for e-mailing activities and may receive/answer e-mails, and after the mails are answered, it sends activity records. Other activities are described as follows.

When the monitor server receives the activity records from the client computers, all the outward activities from the client computers are monitored through the record monitor database and the record module. Each monitor record comprises at least an employee ID, an activity type, and start/end time, so a supervisor may easily know what the certain employees did in certain time.

In order to further know the features and technical means of this invention, refer to the detailed description according to this invention accompanied with drawings; however, the accompanied drawings are provided for reference and illustration only and are not limited to this invention.

### BRIEF DESCRIPTION OF THE DRAWINGS

FIG. 1 is a schematic view illustrating the structure of a real-time overall monitor system according to this invention,

FIG. 2 is a schematic view illustrating the structure of real-time overall monitor system according to this invention,

FIG. 3 is a schematic view illustrating a client computer according to this invention,

FIG. 4 is a schematic view illustrating a monitor server according to this invention,

FIG. 5 is a schematic view illustrating a file master-control interface according to this invention,

FIGS. 6A˜6C are schematic views illustrating a query according to this invention, and

FIGS. 7A˜7B are schematic views illustrating a file authority management according to this invention.

### DETAILED DESCRIPTION OF THE PREFERRED EMBODIMENTS

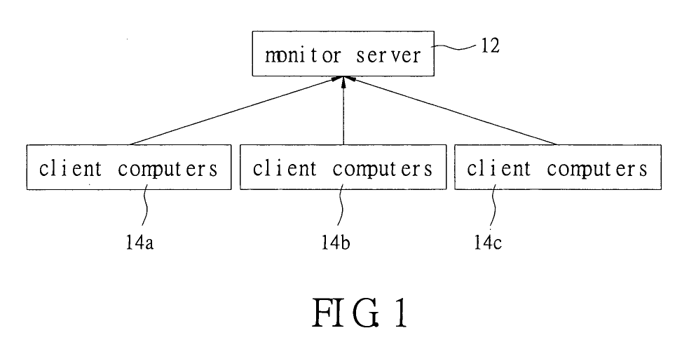

FIG. 1 is a schematic view illustrating the structure of a real-time overall monitor system according to this invention. As shown in FIG. 1, the real-time overall monitor system is mainly structured, for example, with a plurality of client computers 14a, 14b, and 14c, and a monitor server 12. Each of the client computers is mainly used by a certain employee to do all kinds of activities in working hours, such as file upload, Internet surfing, web phone, e-mailing and the like, and after the activities are done, it sends activity records. In order to monitor all the outward activities from the client computers 14a, 14b, and 14c, the activity records are received and kept by the monitor server 12, and generated files and external files are stored in the server 12. In spite of files stored in the client computers 14a, 14b, and 14c, the files are eliminated at a specified time for recovery of the computers 14a, 14b, and 14c to a state at which no file is stored so that the employees are forced to store the files in the monitor server 12.

The structure as shown in FIG. 1 may be expanded from headquarters to branches, and the structures provided in headquarters and branches respectively comprise monitor servers that may the plurality of client computers. The server in headquarters may control the settings of monitor servers in branches so that the server in headquarters may communicate with and control the monitor servers in branches. Thus, the monitor in headquarters may monitor the client computers installed in all the branches.

In short, the activity record comprises at least the employee ID, the activity type, and the start/end time and the employees must use the suite of application installed in the client computers 14a, 14b, and 14c to do activities for file upload, Internet surfing, web phone, e-mailing and the like almost in working hours every day, so the supervisor, such as an owner or a director, may collect the activity record by means of the monitor server 12 to keep track of all the activities done by the employees completely and timely.

An identical interactive mode exists between the monitor server 12 and the client computers 14a, 14b, and 14c, so only the client computer 14a is taken for an example to illustrate the operation of system according to this invention, which is easily understood.

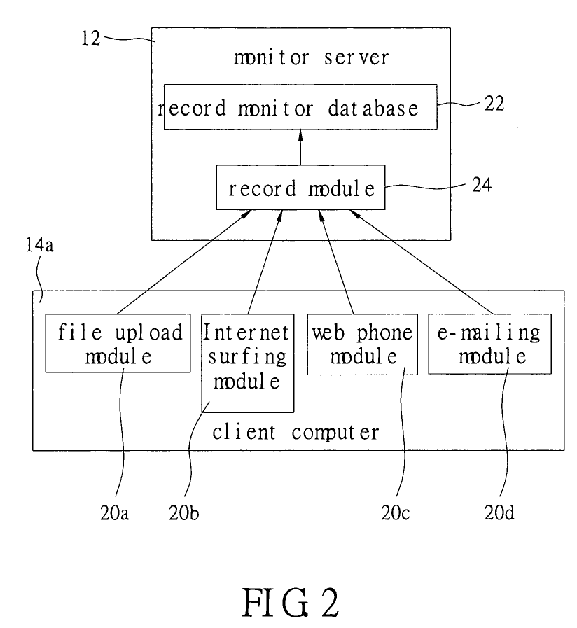

FIG. 2 is a schematic view illustrating the structure of real-time overall monitor system according to this invention. As shown in FIG. 2, the monitor server 12 provided in the real-time overall monitor system also comprises a record monitor database 22 and a record module 24, while the client computer 14a also comprises a file upload module 20a, an Internet surfing module 20b, a web phone module 20c, and an e-mailing module 20d.

Monitoring only for the activities of file upload, Internet surfing, web phone, and e-mailing, the owner or director almost may completely keep track of the working states of employees. Thus, the client computer 14a comprises only the file upload module 20a, the Internet surfing module 20b, the web phone module 20c, and the e-mailing module 20d, and only the four modules are monitored.

When the employees use the file upload module 20a, the Internet surfing module 20b, the web phone module 20c, and the e-mailing module 20d to do the relative activities, in addition to the relative services of phone call, data search on Internet and the like, each module, namely application, offers a service of delivery of the relative activity records to the monitor server 12. When the monitor server 12 receives the records, the record module 24 write the records to a relative record area in the record monitor database 22 according to the type of activity in the activity records sent from the client computer 14a.

Concretely, if each of the plurality of monitor records stored in the record monitor database 22 comprises at least the employee ID, the activity type, and the start/end time and is provided with record areas for the file upload, the Internet surfing, the web phone, and the e-mailing, after receiving activity records of web phone, the record module 24 will store them in the record area of web phone. What we especially pay attention to is the record area that may not need to be subdivided into several relative areas according to the activities, but it is recommended that the area is subdivided into relative areas for data access and management according to the activities.

The file upload module 20a provided in the client computer 14a mainly allows the user to upload files. The files may be uploaded to a server, such as the monitor server 12, through FTP protocol and may be attached and sent to the server through SMTP protocol, or through SFTP protocol, HTTP protocol or the like. Regardless any of the manners cited above, after receiving the files, the server temporarily stores them in a specified directory according to a default file storage path and provides classified directory boxes that are pre-arranged for the user to further rearrange. The classified directory boxes are mainly defined by authorized owner or directors to avoid everyone from defining the boxes by her/his habit, making the owner or directors have no idea of managing the files classified.

In order to collect and monitor the files for management, the owner or directors must ask the employees to store created files or external files in the monitor server 12, and in order to implement the request, additional files stored in the client computers 14a, 14b, and 14c may be eliminated at a specified time for recovery of the computers 14a, 14b, and 14c to a state at which no file is stored.

The client computer 14a is not allowed to store any file, so all files must be uploaded though the file upload module 20a and is then stored in the server. Thus, the owner or directors may track how many files all the employees created depending on the activity records received by the monitor server 12. With the relative authority and the names of groups classified for the files systematically stored by the employees, the owner or directors may at any time survey the files and never mind where the employee who asks for leave stores his/her files and never mind an issue that the employee who resigns does not hand over his/her tasks completed and not completed.

Similarly, the Internet surfing module 20b must be used to surf on Internet, the web phone module 20c must be used to give and answer the web-phone, and the e-mailing module 20d must be used to send and receive e-mails, so the owner or directors may keep track of what all the employees did depending on the activity records received by the monitor server 12.

The Internet surfing module 20b is less different from a suite of software for a general browser; however, the records of Internet surfing are not only recorded in the client computer 14a but sent to the monitor server 12; namely, the records of activity for Internet surfing are automatically sent to the monitor server 12. In this way, the owner or directors may at any time know which websites specific employees surfed on, and Internet surfing start time and end time through the monitor server 12.

In the system according to this invention, general fixed-network phone call functions, especially the phone call function, have been replaced with the web phone module 20c, so regarding the activity of phone call, the employees use the web phone module 20c working on Internet to dial to talk by telephone, and then the activity record of phone call is sent out. Thus, by search, the owner or directors may know whom the employees gave calls to and how long them talked on the telephone. Besides, in order to keep track of coming call signals transmitted to telephone systems, the analog signals received by the telephone systems may be converted to digital ones, outputted to the client computers, and answered by the client computers; afterwards, the client computers may send the records to the monitor server. The e-mailing module 20d may send and receive e-mails and send the record of activity after sending and receiving e-mails. Monitoring the activity of e-mail delivery and receiving through the monitor server 12, the owner or director may easily know how many e-mails the employees received and answered, determining whether they work hard or not. Further, the e-mailing module 20d may store all e-mails in the monitor server 12 so that the owner or directors may incidentally read specific e-mails by search.

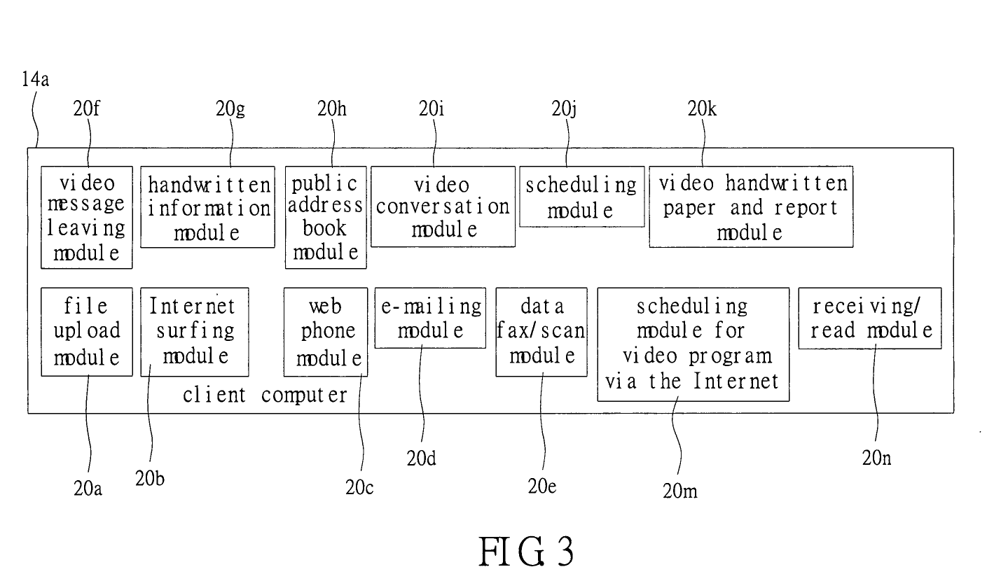

FIG. 3 is a schematic view illustrating client computers according to this invention. As shown in FIG. 3, in addition to the file upload module 20a, the Internet surfing module 20b, the web phone module 20c, and the e-mailing module 20d, the client computer 14a according to this invention may comprise a data fax/scan module 20e, a video message leaving module 20f, a handwritten information module 20g, a public address book module 20h, a video conversation module 20i, a scheduling module 20j, a video handwritten paper and report module 20k, and a scheduling module 20m for video program via the Internet. In order to smoothly deal with the extra modules, the monitor record database 22 must be provided additionally with records areas for data fax/scan, video message leaving, handwritten information, address book, video conversation, scheduling, video handwritten paper and report, and scheduling for video program via the Internet.

A conventional scanner outputs papers and the owner and directors cannot easily survey, so the conventional scanner must be replaced with the data fax/scan module 20e. Concretely, the data fax/scan module 20e controls a scanner during scan and then send out the record after the scan. Thus, the paper given from scan activity is changed into an e-file that may be stored and printed. Besides, the conventional scan activity may be implemented with the scanner and then Internet Fax, and in the method of converting analog signals into digital signals, scanned files may be sent to a computer through Internet Fax so that the conventional scanner may also be substituted with the data fax/scan module 20e and the Internet Fax.

In consideration of evidence and convenience, writing on papers is usually required to convey certain pieces of information or data reports. However, it is similar to photocopy, and the authorized owner and directors cannot easily survey the papers, and the handwritten information module 20g is required for the activity of handwriting on a handwritten board, and then the record is sent out. If the employees are asked to write in this manner, the owner and directors may also easily monitor this activity. Next, at the time of group discussion, an electronic handwritten whiteboard may also be used to keep the complete record of discussion for the owner and directors to get.

In the conventional activities of scheduling, visit to customers and the like, notes are taken in paper-made notebooks or digital to-do lists in personal computers and thus others cannot at any time track the employees' schedule and record on visit to customers. Thus, if the scheduling module 20j is alternatively used to manage the activity of schedule, the schedule may be managed and reserved and leave activity may be recorded; afterwards, the records of activities are sent out and kept in the monitor server 12 so that people who are relatively authorized may easily track the schedules having finished and pre-made by the employees for visit to customers.

The problem of management of an address book in e-mail also occurs as that of scheduling; namely, others cannot at any time track customers lists kept by the employees. Accordingly, the employees are asked to use the public address book module 20h for the activity upon address book, and the address book may be maintained. After the address book is maintained, the record of activity is sent out, and thus the problems on the address books and customer lists kept by the employees that are not conventionally timely managed and shared may be solved.

The video conversation module 20i is provided for users to do the activity of video conversation, including that of real-time video discussion on official files through an optional mini camera, and after the video conversation, the record of activity is sent out. The video message leaving module 20f is used for the activity of video message leaving that may be implemented with the mini camera, and after the activity, the record of activity is sent out and kept in the monitor server 12. The video handwritten paper and report module 20k is quite similar to the video conversation module 20i and may make document-based reports provided with images and sounds; similarly, after the activity, the record of activity is also sent out and the generated e-files are stored in the monitor server 12.

a scheduling module 20m for video program via the Internet provides schedule reminders with images and sounds; afterwards, the record of activity may be sent to the monitor server 12.

A receiving/read module 20n is used to read the information of activity that is received by the data fax/scan module 20e, the video massage leaving module 20f, the video handwritten paper and report module 20k, and the scheduling module 20m for video program via the Internet, and after the activity, the record is sent to the monitor server 12.

The video conversation, video message leaving, and even other related video activities, such as receiving and delivery of video documents and handwritten mails, are novel categories of activities. Although no related activity exists conventionally, the activities are done digitally so that they may be monitored. Thus, if they may be monitored, the power of overall monitor according to this invention may further increase.

To sum up, the suites of required application are provided in the client computer 14a for file upload, Internet surfing, web phone, e-mailing, data fax and scan, scheduling, video conversation, video message leaving, video handwritten papers and reports, handwritten information, address book, and scheduling for video program via the Internet as activities in working hours, and the employees are forced to use the suites of application to do activities they may in working hours; thus, all the outward activities done on the client computer 14a are monitored and overall controlled.

In addition to all the records of activities that are given by the client computer 14a, in order for the owner and directors to monitor, the monitor server 12 certainly will provide relative modules, namely suites of application.

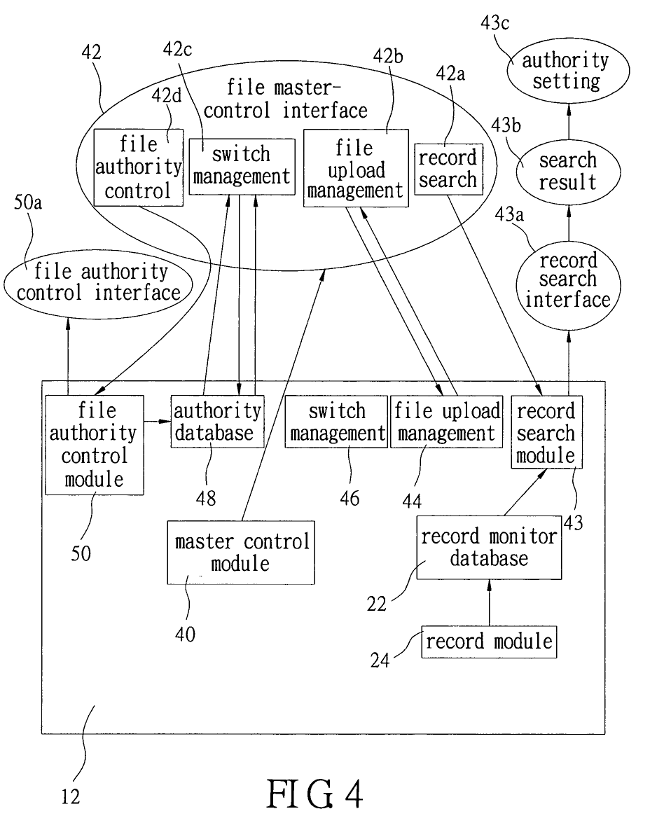

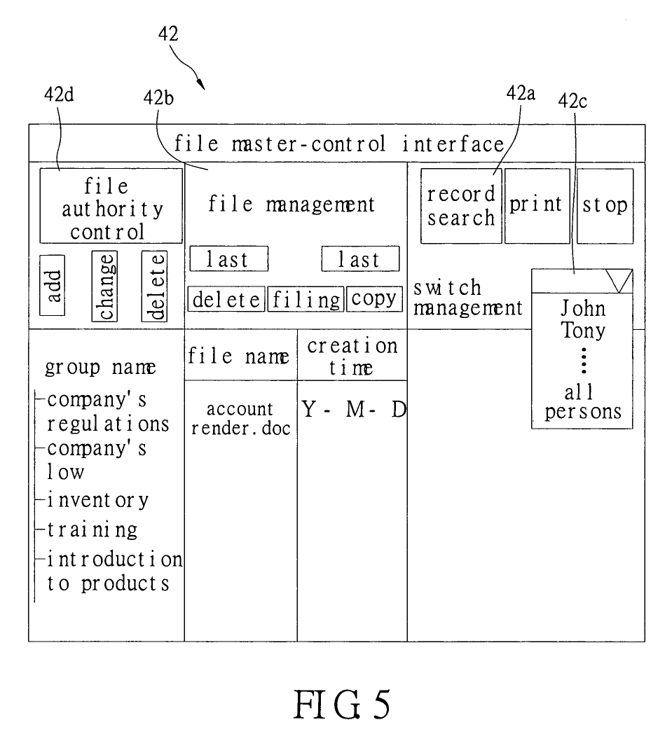

FIG. 4 is a schematic view illustrating the monitor server according to this invention. As shown in FIG. 4, in addition to the record module 24 and the record monitor database 22, in order for the owner and directors to monitor, the monitor server 12 comprises a master-control module 40, a record search module 43, a file upload management module 44, a switch management module 46, an authority database 48, and a file authority control module 50.

The master-control module 40 mainly provides a file master-control interface 42 interactive with the user, function keys on the file master-control interface 42 are those for record search 42a, file upload management 42b, file authority control 42d, and switch management 42c. When a supervisor presses a specific function key, relative operation is performed.

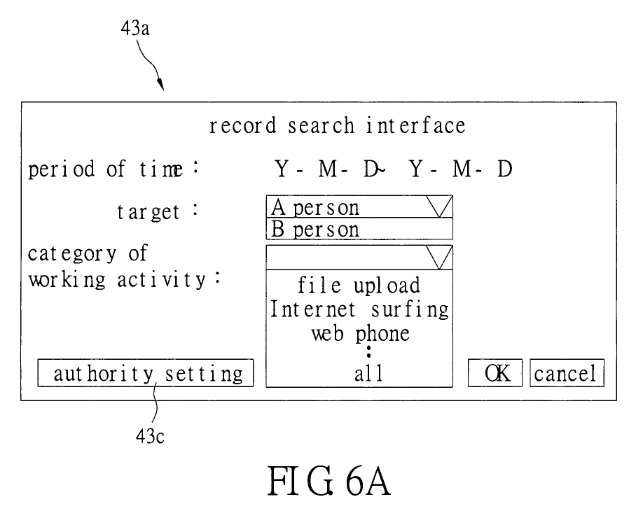

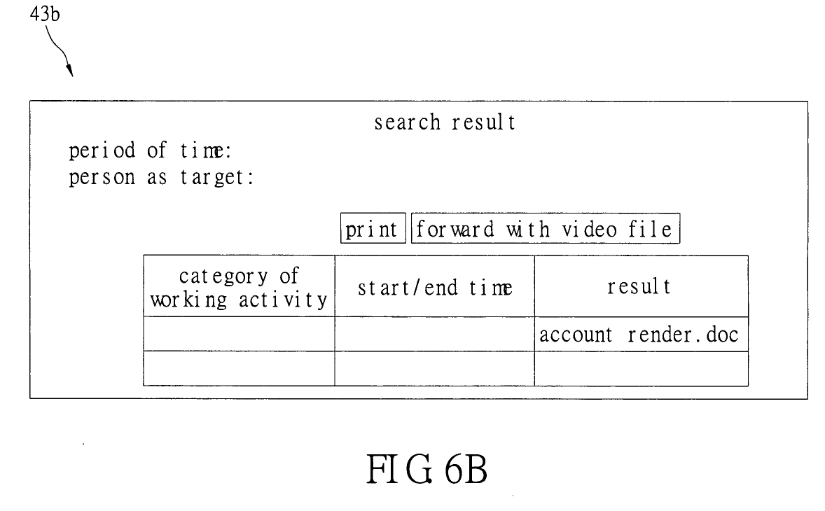

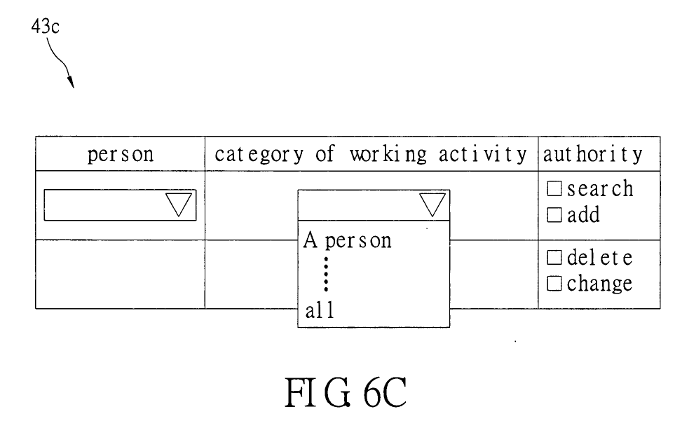

When the function key for record search 42a is pressed, the record search module 43 shows a record search interface 43a, as shown in FIG. 6A. Next, the supervisor may query the records on the interface, and after the supervisor determines a query period of time, a target, and an activity category, the record search 42a finds required data in the record monitor database 22 and shows relative results 43b, as shown in FIG. 6. The search result comprises at least an employee ID, an activity type, and start/end time, so the supervisor may completely and timely keep track of the working states of employees.

When the function key for file upload management 42b is pressed, the file upload management module 44 shows a file upload management menu, as shown in FIG. 5, so that the supervisor may manage the uploaded files; after a file maker determines how to file away the specific files, the supervisor practically return them back to file. By so doing, the directors may find in the record search module the working status of specific employees depending on all work categories and specific dates, and the working status comprises the records of activities returned by each module, as shown in FIG. 3.

Reading relative authority information in the authority database 48, the switch management module 46 shows a switch management menu, as shown in a component 42c of FIG. 5. When the function key (or a mode executed after selection) for the switch management 42c is pressed, the switch management module 46 may let the supervisor switch for management of a specified person or specified persons; namely, a specified person's account may be shown to search all the files and data owned by the person.

Concretely, a plurality of authority information is stored in the authority database 48 and each piece of information is corresponding to a specified engineer. Each piece of authority information comprises at least subordination relationship, read authority based on subordination relationship, add authority, change authority, and delete authority. Thus, when the switch management module 46 shows a list of targets in the menu of switch management 42c according to the subordination relationship of authority information in the authority database 48, if the supervisor selects a specified employee in the list of targets, an employee file list is shown and the supervisor may use all the functions to query and use data according to the read authority, add authority, change authority, and delete authority in the authority information as the employee manages the uploaded files using his or her account.

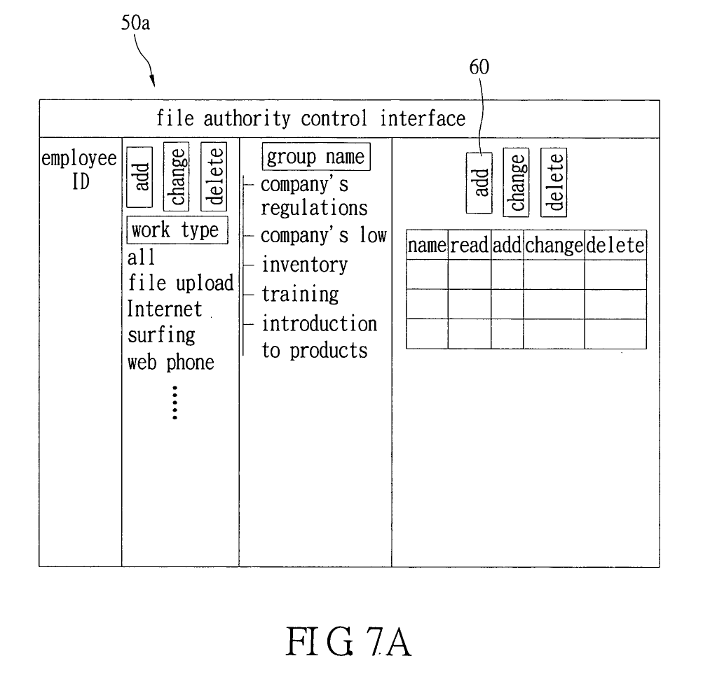

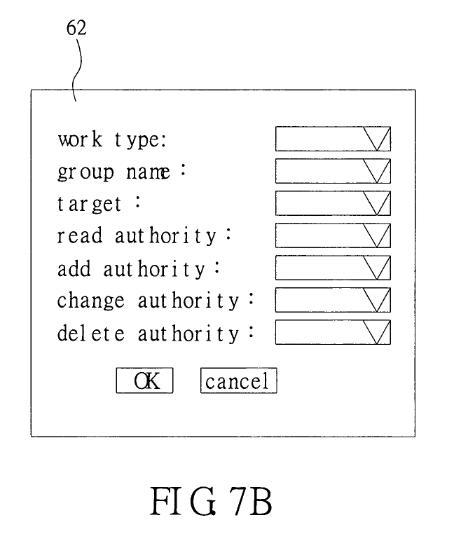

The authority information stored in the authority database 48 is controlled by the file authority control module 50 for file authority control; namely, when the supervisor presses the file authority control 42d, the file authority control module 50 shows a file authority control interface 50a, as shown in FIG. 7A, for the supervisor to manage the files and functions. After the supervisor determines to control the authority of the specified employee, the relative authority information in the authority database 48 is changed.

The following embodiments are given to describe the file master-control interface 42, the record search interface 43a, the result search 43b, and the file authority control interface 50a. However, due to the related functions and virtues cited above, it is especially noted that the following embodiments do not have an effect on any coming modification and change.

FIG. 5 is a schematic view illustrating the file master-control interface according to this invention. As shown in FIG. 5, the function key on the file master-control interface 42 comprises record search 42a, file upload management 42b, file authority control 42d, and switch management 42c. When being enabled, the file master-control interface 42 shows the function key and fetches a list of files, such as Company A Account Renderdoc, uploaded from the server depending on the command of operator and a list of external file items, such as Company's Regulations, Company's Flow . . . , that nay be viewed and displayed according to the authority.

The switch management 42c in the form of menu is more easily implemented to select a target than that in the form of manual typing, so in the embodiment, the switch management 42c is in the form of menu. When switching to a specified employee, the user gets the list of uploaded files and the list of external file items that may be viewed and displayed according to the employee's authority and gets the specified employee's other data that is the function of each module shown in FIG. 3. Thus, the authorized supervisors may use the function to easily get the files and the employee's data they want, not feeling nervous about the employee's leave or resignation.

The function key for file upload management 42b is not virtually a single key but may be the buttons of deletion, filing, copy and the like as shown in FIG. 5 for file upload management. However, little difference is found on the whole between the file upload management and the conventional file management, so detailed description is not made herein.

FIGS. 6A˜6B are schematic views illustrating a query according to this invention. When the user clicks the record search 42a, the record search module 43 shows the record search interface 43a as shown in FIG. 6A. The targets may cover the employees of branches according to the authority of person who searches, while the category of activity may be optionally searched by the supervisor. In short, after the period of time, the target, and the category of activity, as shown in FIG. 3 for the activities of each module, are selected, the record search module 43 shows the results 43b as shown in FIG. 6B according to the data in the record monitor database 22. If query among the targets is required for add and change, the function for search authority 43c must be clicked, as shown in FIG. 6C.

FIGS. 7A˜7B are schematic views illustrating the file authority management according to this invention. After the user clicks the file authority control 42d, the file authority control module 50 shows the file authority control interface 50a as shown in FIG. 7A. When the file authority control interface 50a is enabled, the file authority control 42d also gets established authority data from the authority database 48 and shows it by name with the authorities or authority of read, add, change, and/or delete. If the authorities of add, delete, and change are required, the relative function key on the file authority control interface 50a may be further clicked, and the authority of add is taken into an example as follows.

When the user clicks the “Add” button 60 for adding a control authority, the file authority control module 50 shows the file authority control menu 62 as shown in FIG. 7B. In the file authority control menu 62, a specified target, a specified group name, or a specified category or all categories may be selected to obtain the target's authorities of read, add, change, and delete that are corresponding to the category and group name. After the authorities are obtained, switch to the target on the file master-control interface 42 shown in FIG. 5 may be implemented. Then, the files are managed according to the set authorities.

To sum up, the real-time overall monitor system according to this invention may keep the records of activities done by the employees on their computers, in which the records of activities are inclusively the operation of all modules or other functional modules for the computers, as shown in FIG. 3, and may fully use data to evaluate all employees on performance, which is more objective than a conventional measure that evaluate the employees on the extent of earnest devotion to their tasks. Thus, this invention makes the employees be absorbed in their business and deters them from dealing with their personal affairs, thereby the work efficiency in whole company being effectively promoted.

However, in the description mentioned above, only the preferred embodiments according to this invention are provided without limit to claims of this invention; all those skilled in the art without exception should include the equivalent changes and modifications as falling within the true scope and spirit of the present invention.

What is claimed is:

1. A real-time overall monitor system used to completely keep track of the executive state of activity done by an employee who has an employee ID, comprising:
a client computer provided for the employee to do various working activities and then sending out a record of activity, the record comprising at least the employee ID, an activity type, and start/end time, the client computer comprising:
a file upload module used to upload files and then sends out the record of activity;
an Internet surfing module that is used for Internet surfing, may access information on a website over Internet, and then sends out the record of activity after Internet surfing;
a web phone module used for an activity on the web phone and receiving, sending a telephone number via the Internet for conversation, and then sending out the record of activity; and
an e-mailing module being used for an e-mailing activity, receiving and sending e-mails, and then sending out the record of activity; and
a monitor server being used to monitor all the outward activities on the client computer, the monitor server comprising:
a record monitor database being used to store a plurality of monitored records, each of the records comprising at least the employee ID, the activity type, and the start/end time and being provided with record areas for the file. upload, the Internet surfing, the web phone, and the e-mailing; and
a record module being used to write the record of activity to the corresponding record area according to the type of activity in the record sent from the client computer.

2. The real-time overall monitor system according to claim 1, wherein the monitor server further comprises:
a master-control module comprising at least a file master-control interface on which a function keys are provided for record search, file upload management, file authority control, and switch management, a supervisor clicking the functions keys to perform relative operations.

3. The real-time overall monitor system according to claim 2, wherein the monitor server further comprises:
a record search module showing the supervisor a record search interface for query after the supervisor clicks the function key of record search and showing a relative result after the supervisor determines to query for a query period of time, a target, and an activity category, the result comprising at least the employee ID, the activity type, and the start/end time.

4. The real-time overall monitor system according to claim 2, wherein the monitor server further comprises:
a file upload management module giving a file upload management menu to the supervisor to manage the uploaded files after the supervisor clicks the function key for file upload management and practically returning them back to file after the supervisor determines how to file away the specific files.

5. The real-time overall monitor system according to claim 2, wherein the monitor server further comprises:
an authority database storing a plurality of authority information each of which is corresponding to the specified employee and comprising at least a subordination relationship and a read authority, an add authority, a change authority, and a delete authority based on the subordination relationship.

6. The real-time overall monitor system according to claim 4, wherein the monitor server further comprises:
a file authority control module providing a file authority control interface to the supervisor to conduct the file authority control after the supervisor clicks the function key for file authority control and changing the relative authority information in the authority database after the supervisor determines to control the authority of the specified employee.

7. The real-time overall monitor system according to claim 4, wherein the monitor server further comprises:
a switch management module providing a switch management menu to the supervisor to switch for management after the supervisor clicks the function key for switch management, showing a list of targets in the switch management menu according to the subordination relationship of authority information in the authority database, showing the list of files of the employee after the specified employee in the list of targets is selected, and managing the uploaded files according to the read authority, add authority, change authority, and delete authority in the authority information.

8. The real-time overall monitor system according to claim 1, wherein the record monitor database also comprises a record area for data scan and fax and the client computer further comprises:
a data fax/scan module that is used for the activity of data fax and scan, may controls a scanner during scan, and then sends out the record after the scan.

9. The real-time overall monitor system according to claim 8, wherein the record monitor database also comprises a record area for receiving and read and the client computer further comprises:
a receiving/read module being used to read the fax and scan data received by the data fax/scan module and then sending out the record of activity.

10. The real-time overall monitor system according to claim 1, wherein the record monitor database also comprises a data record area for scheduling and the client computer further comprises:
a scheduling module that is used to manage the activity of schedule, may manage and reserve schedules, and then sends out the record of activity.

11. The real-time overall monitor system according to claim 1, wherein the record monitor database also comprises a record area for video conversation and the client computer further comprises:
a video conversation module that is used to do the activity of video conversation, may be used for video conversation through an optional mini camera, and then sends out the record of activity.

12. The real-time overall monitor system according to claim 1, wherein the record monitor database also comprises a record area for video messaging leaving and the client computer further comprises:
a video message leaving module that is used to do the activity of video message leaving, may be used for video message leaving through an optional mini camera, and then sends out the record of activity.

13. The real-time overall monitor system according to claim 12, wherein the record monitor database also comprises a record area for receiving and read and the client computer further comprises:
a receiving/read module being used to read the video message received by the video message leaving module and then sending out the record of activity.

14. The real-time overall monitor system according to claim 1, wherein the record monitor database also comprises a record area for handwritten information and the client computer further comprises:
a handwritten information module that is used to do the activity of handwritten information, may be used for handwriting on a handwriting board, and then sends out the record of activity.

15. The real-time overall monitor system according to claim 1, wherein the record monitor database also comprises a record area for address book and the client computer further comprises:
a public address book module that is used for the activity upon address book, may maintain the address book, and then sends out the record of activity.

16. The real-time overall monitor system according to claim 1, wherein the record monitor database also comprises a record area for documents and papers and the client computer further comprises:
a video handwritten paper and report module being used to make document-based reports provided with images and sounds and then sending out the record of activity.

17. The real-time overall monitor system according to claim 16, wherein the record monitor database also comprises a record area for receiving and read and the client computer further comprises:
a receiving/read module being used to read the document-based reports provided with images and sounds received by video handwritten paper and report module and then sending out the record of activity.

18. The real-time overall monitor system according to claim 1, wherein the record monitor database also comprises a record area for video schedule and the client computer further comprises:
a scheduling module for video program via the Internet being used to make schedule reminders with images and sounds and then sending out the record of activity.

19. The real-time overall monitor system according to claim 18, wherein the record monitor database also comprises a record area for receiving and read and the client computer further comprises:
a receiving/read module being used to read the video mails made by the scheduling module for video program via the Internet and then sending out the record of activity.
